(19) United States
(12) Patent Application Publication
(10) Pub. No.: US 2024/0246212 A1
(43) Pub. Date: Jul. 25, 2024

(54) DRIVING TOOL

(71) Applicant: Makita Corporation, Anjo-shi (JP)

(72) Inventors: Kiyonobu Yoshikane, Anjo-shi (JP); Shun Kuriki, Anjo-shi (JP)

(73) Assignee: Makita Corporation, Anjo-shi (JP)

(21) Appl. No.: 18/541,199

(22) Filed: Dec. 15, 2023

(30) Foreign Application Priority Data
Jan. 20, 2023 (JP) 2023-007296

(51) Int. Cl. B25C 1/04; B25C 1/00

(52) U.S. Cl. CPC B25C 1/047; B25C 1/005; B25C 1/008; B25C 1/06

(57) ABSTRACT

An engaging portion of a driver has an engaging portion front surface coplanar with a striking portion front surface and an engaging portion rear surface coplanar with a striking portion rear surface. The engaging portion has an engagement surface that is parallel to a rotation axis of a lifter.

### CROSS-REFERENCE TO RELATED APPLICATIONS

This application claims the benefit of priority to Japanese patent application serial number 2023-007296, filed Jan. 20, 2023, the entire contents of which are incorporated herein by reference in its entirety for all purposes.

### BACKGROUND

The present disclosure relates to a driving tool for driving a driven member into a workpiece.

Prior art discloses a gas spring type driving tool that utilizes compressed gas pressure as a striking force. The gas spring type driving tool has a piston that moves up and down in a cylinder and a driver coupled to the piston. The piston and driver move downward in a driving direction due to gas pressure in a pressure accumulation chamber. The driver moves through a driving channel to strike a driven member. The piston and driver return in a counter-driving direction by a lift mechanism.

The lift mechanism has a wheel that is rotated by an electric motor. After driving operation, the wheel rotates, and the wheel successively engages with engaging portions of the driver. This causes the driver to return in the counter-driving direction. When the piston is returned in the counter-driving direction, gas pressure within the pressure accumulation chamber increases. When the driver is returned, a driven member will be fed in the driving channel. Near motion end in the counter-driving direction, the lift mechanism is disengaged from the driver. This allows the driver to move by the gas pressure so as to drive the driven member.

The driving tool is equipped with a magazine that accommodates a number of driven members. A front end of the magazine in a feeding direction is coupled to the driving channel. A large magazine is mounted, for example, on a left side around a driving axis and held at an angle to ensure a compact arrangement while avoiding interference with the lift mechanism. In this case, the feeding direction of the driven members from the magazine is inclined to an axis of rotation of the wheel. Therefore, the driven members are shifted to one side around the driving axis and is fed into the driving channel in an inclined position.

A striking portion to strike a driven member, is planar in shape. The striking portion has a plurality of engaging portions that are engaged with the wheel of the lift mechanism. Since the driven members are positioned inclined in the driving channel, the striking portion and engaging portions are inclined to each other. When fabricating a driver with such striking and engaging portions by cutting, it is necessary to prepare a material with a large plate thickness. This requires many machining processes and leads to high costs. In contrast, a magazine may be equipped parallel to the axis of rotation of the wheel. In this case, the driven members are fed in a regular position where a center of width of the driven member is located at a center of left and right widths of the driving channel. The driver used in this case may be an inexpensive driver in which the striking portion and engaging portion are provided on the same surface. The object of the present disclosure is to reduce a cost of a driver in a driving tool with a magazine in which driven members are fed in an inclined position.

### SUMMARY

According to one aspect of the present disclosure, a driving tool has a driver that moves from up to down to strike a driven member. A lifter is provided on either left side or right side of the driver. The lifter rotates around a rotation axis extending in a front-rear direction to return the driver to its initial position. A magazine is provided on an opposite side of the lifter to the driver. The magazine feeds driven members from rear to front at a feeding angle inclined in a left-right direction relative to the rotation axis of the lifter. The driver is planar with its thickness direction oriented in the feeding direction of the driven members. The driver has a striking portion that strikes the driven member and a plurality of engaging portions that project from the striking portion toward the lifter to engage successively with the lifter. Each engaging portion has an engaging portion front surface coplanar with a front surface of the striking portion and an engaging portion rear surface coplanar with a rear surface of the striking portion. Engagement surfaces of the plurality of engaging portions are configured in a plane that is substantially parallel to the rotation axis.

Therefore, since the striking portion and the rack portion have coplanar front and rear surfaces, the driver can be manufactured with minimal machining allowance using a flat plate-shaped material of sufficient thickness to form the striking portion and the engaging portion by cutting. This makes it possible to reduce the cost of the driver in driving tools with a magazine in which the driven members are fed in an inclined position along a direction inclined to the left or right with respect to the rotation axis of the lifter.

Another aspect of the present disclosure relates to a method of machining a driver for a driving tool. The driving tool has a driver that strikes a driven member downward. A lifter is provided on either left or right side of the driver. The lifter rotates around a rotation axis extending in a front-rear direction to return the driver to its initial position. The magazine may feed driven members, for example, from rear to front at a feeding angle inclined in a left-right direction relative to the rotation axis of the lifter.

According to another aspect of the present disclosure, a flat plate-shaped material, for example, may be set in a cutting machine so that its thickness direction is up and down. Next, a top surface of the material is cut into a single flat surface to form a front surface of the driver. Subsequently, the material is set upside down so that a bottom surface faces upward, and the bottom surface of the material is cut into a single flat surface to form a rear surface of the driver. The material is then set on the cutting machine using a machining jig so that the top surface of the material is at a feeding angle with respect to a setting surface of the cutting machine. Next, a rotary cutting tool is moved along an edge of the material to form a plurality of engaging portions of the driver on the edge. Next, the material is set on the cutting machine so that the top surface of the material is parallel to the setting surface of the cutting machine. Next, the rotary cutting tool is moved along the top surface to form a guide groove extending in a longitudinal direction of the material. When the driver is provided to the driving tool, the engaging portions engage with the lifter.

Therefore, by cutting a material of sufficient thickness required for the material with a small machining allowance, a driver for striking a driven member with its feeding angle inclined to the rotation axis of the lifter can be produced at a low cost. The plurality of engaging portions is cut after the top surface of the material is inclined and re-set to be at the feeding angle.

### BRIEF DESCRIPTION OF THE DRAWINGS

FIG. 1 is a perspective view of an entire driving tool from a front diagonally left side.

FIG. 2 is a left side view of the driving tool.

FIG. 3 is a bottom view of the driving tool as viewed from an arrow III in FIG. 2.

FIG. 4 is a top view of the driving tool as viewed from an arrow IV in FIG. 2.

FIG. 5 is a front view of an internal structure of a tool body and a driving tool nose portion as viewed from an arrow V direction in FIG. 2. This view illustrates a stand-by state in which the driver is positioned in an initially position.

FIG. 6 is a front view of the internal structure of the tool body and the driving nose portion as viewed from the arrow V direction in FIG. 2. This view illustrates a driving state in which the driver is positioned at a downward motion end.

FIG. 7 is a cross-sectional view taken along the line VII-VII in FIG. 2.

FIG. 8 is an enlarged view of an area VIII in FIG. 7.

FIG. 9 is a front view of the driver as viewed from a direction of arrow IX in FIG. 8 (a direction of a feeding axis M of a magazine).

FIG. 10 is a left side view of the driver as viewed from a direction of arrow X in FIG. 9.

FIG. 11 is a bottom view of the driver from a direction of arrow XI in FIG. 9.

FIG. 12 is a view illustrating a machining process of the driver. This shows a process of cutting a top surface of a material to form a front surface of the driver.

FIG. 13 is a view illustrating the machining process of the driver. This shows a process of cutting a bottom surface of the material to form a rear surface and a relief surface of the driver.

FIG. 14 is a view illustrating the machining process of the driver. This shows a process of cutting each engaging portion using a machining jig.

FIG. 15 is a view illustrating the machining process of the driver. This shows a process of cutting a guide groove on a striking portion front surface.

### DETAILED DESCRIPTION

In an embodiment, a number of engagement pins are arranged along an outer circumferential edge of a lifter and successively engage with a number of engaging portions of a driver. Accordingly, the driver returns upward when engagement pins successively engage with the engaging portions.

In another embodiment, the lifter may have a front flange to support a front end of the engagement pins, and a rear flange to support a rear end of the engagement pins. Thus, the engagement pins are supported at both ends by the front and rear flanges of the lifter, respectively.

In another embodiment, the engaging portion rear surface of the driver may have a relief surface that is inclined with respect to the engaging portion rear surface to avoid interference with the rear flange of the lifter. Thus, the driver may be compactly arranged with respect to the lifter while avoiding interference of the engaging portion rear surface with the rear flange.

In another embodiment, the driving tool may have a piston that is movable by gas pressure. The driver has a plate-shaped coupling portion that is coupled to the piston. A front surface of the coupling portion is flush with the striking portion front surface, and a rear surface of the coupling portion is flush with the striking portion rear surface. Thus, the driver is coupled to the piston via the coupling portion that is flush with the striking portion.

In another embodiment, an end of the striking portion may be thinner than a body of the striking portion. Thus, a weight of the driver may be reduced.

In another embodiment, the front flange of the lifter may have a relief surface around an entire circumference that is inclined with respect to a plane orthogonal to the rotation axis to avoid interference with the engaging portion front surface. Thus, the driver is compactly arranged with respect to the lifter while avoiding interference of the engaging portion front surface with respect to the front flange of the lifter.

In another embodiment, the feeding angle of the magazine may be 5° to 15° with respect to a direction parallel to the rotation axis of the lifter. Thus, the driven members are fed into the driving channel in an inclined position that is inclined 5° to 20° to the plane orthogonal to the rotation axis of the lifter.

In another embodiment, after forming a rear surface of the driver, a rear side corner of the material may be cut in a direction inclined at the feeding angle to form a relief surface to avoid interference of the engaging portion with respect to the lifter. Thus, after cutting the relief surface of the engaging portion, a plurality of engaging portions is cut by setting the material so that a top surface of the material is at the feeding angle using, for example, a machining jig.

### EMBODIMENTS

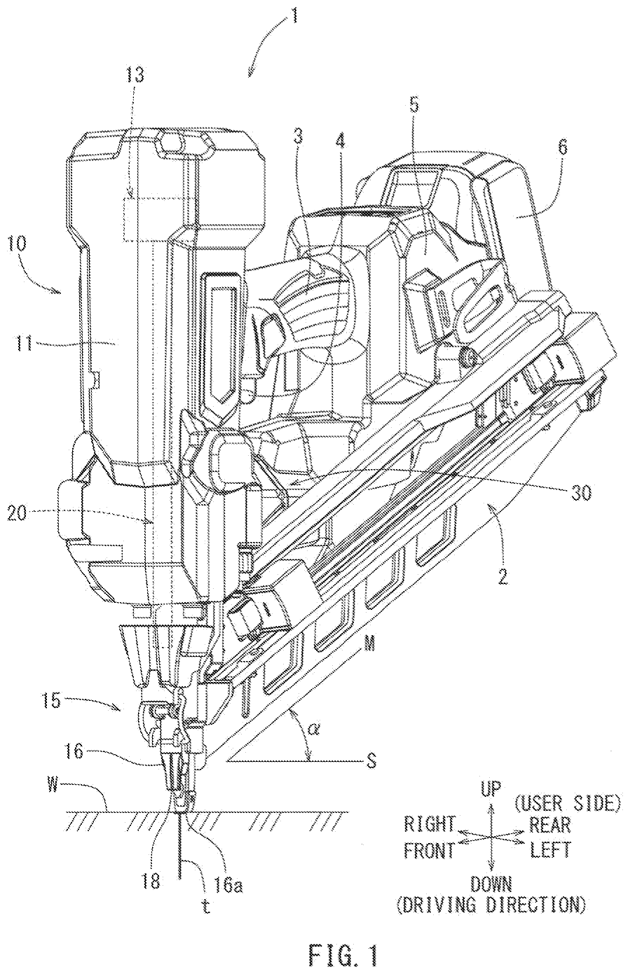

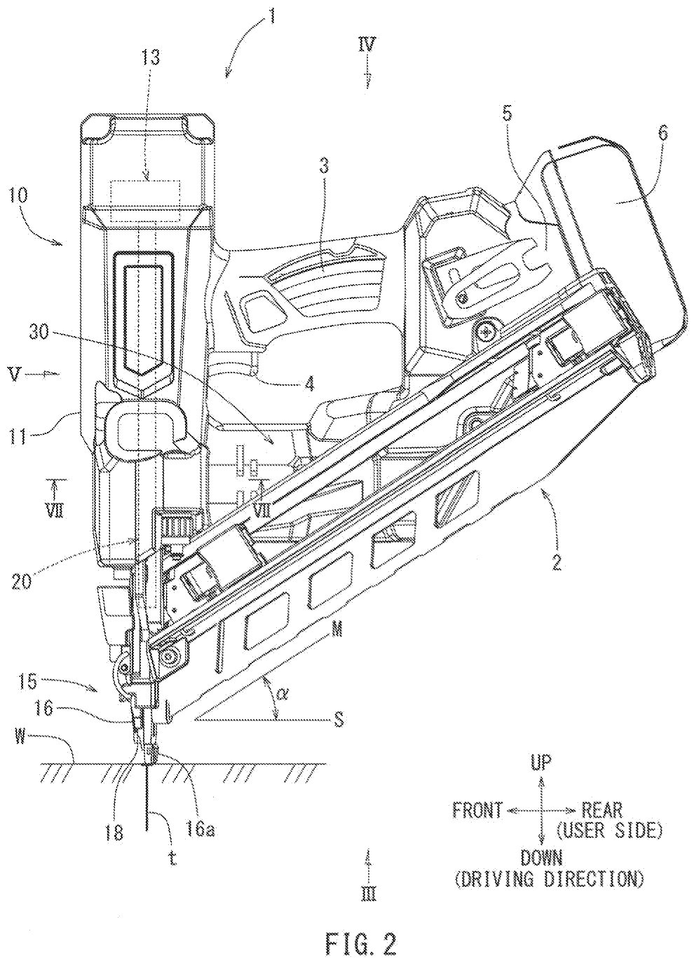

In an embodiment of the present disclosure, a gas spring driving tool will be illustrated as an example of a driving tool 1. This tool uses gas pressure in a pressure accumulation chamber above a cylinder as a thrust force for driving a driven member t. For example, a rod-shaped nail may be used as the driven member. In the following description, a driving direction of the driven member t is a downward direction while a counter-driving direction is an upward direction. A user of the driving tool 1 is positioned on a right side (grip 3 side) of the driving tool 1 as illustrated in FIGS. 1 and 2. A side toward the user is a rearward direction (user side), while a side opposite to the user is a frontward direction. Left and right directions are determined based on the user holding the grip 3.

As shown in FIGS. 1 to 6, the driving tool 1 has a tool body 10. The tool body 10 has a substantially cylindrical body housing 11 and a cylinder 12 housed in the body housing 11. A piston 13 is received within the cylinder 12 so as to be reciprocally movable in an up-down direction. An upper portion of the cylinder 12 above the piston 13 is connected to a pressure accumulation chamber 14. The pressure accumulation chamber 14 is filled with compressed gas, such as air. The gas pressure in the pressure accumulation chamber 14 acts as a thrust force on an upper surface of the piston 13 to move the piston 13 downward.

A driving tool nose portion 15 is provided at a bottom of the tool body 10. The driving nose portion 15 has a driver guide 16 and a contact arm 16a. An inner circumferential side of the driver guide 16 is defined as a driving channel 17. The driving channel 17 is communicated to an inner circumferential side of the cylinder 12. A long driver 20 enters the driving channel 17 so as to be reciprocally movable in the up-down direction. Pulling operation of a switch lever 4 becomes effective when the contact arm 16a is pressed against a workpiece W to move relatively upward.

A magazine 2 is coupled to a rear side of the driving nose portion 15. A number of driven members t is loaded in the magazine 2. The driven members t in the magazine 2 are fed along a feeding axis M toward the driving nose portion 15. In conjunction with a driving operation of the tool body 10, the driven members t are fed one by one from the magazine 2 into the driving channel 17 in the driving nose portion 15. One driven member t fed in the driving channel 17 is struck by the downwardly moving driver 20.

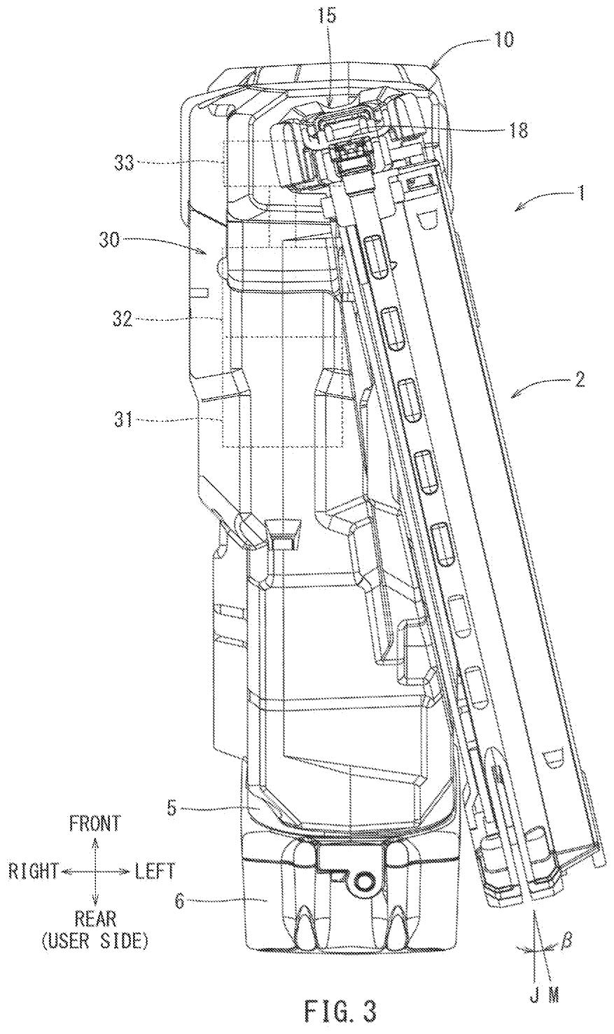

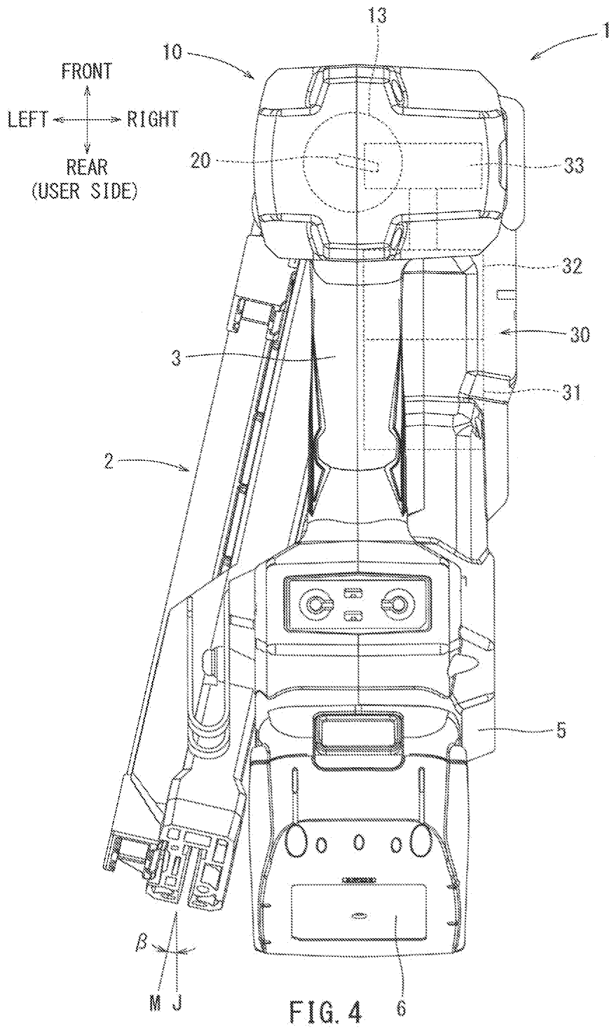

As shown in FIGS. 1 and 2, the magazine 2 extends in a direction inclined at a feeding angle α in a direction where a rear side is displaced upward with respect to a reference plane S orthogonal to the driving direction (up-down direction). Further, as shown in FIGS. 3 and 4, the magazine 2 extends in a direction inclined at a feeding angle β in a direction where the rear side is displaced to the left relative to a rotation axis J of the lifter 33, which is described below. Therefore, the magazine 2 is supported with respect to the driving nose portion 15 in a front-back inclined posture in which the rear side is displaced upward in a side view, and in a left-right inclined posture in which the rear side is displaced to the left in a bottom or top view. The feeding direction (feeding axis M) of the driven member t loaded in the magazine 2 is inclined at the feeding angle α with respect to the reference plane S orthogonal to the driving direction, and at the feeding angle β with respect to the rotation axis J of the lifter 33, which is be described below. For the feeding angle β may be set at about 12.5°. The feeding angle β of the magazine 2 may be changed, for example, within the range of about 5° to 15°.

A grip 3 is provided on a rear side of the tool body 10 for the user to hold. A switch lever 4 for activation, which is operated by the user pulling it with a fingertip, is provided on a front lower side of the grip 3. A battery mounting portion 5 is provided at a rear of the grip 3. A battery pack 6 is mounted on a rear side of the battery mounting portion 5. The battery pack 6 is attachable to and removable from the battery mounting portion 5 by sliding the battery pack 6 in the up-down direction. The battery pack 6 is removed from the battery mounting portion 5 and charged with a separately prepared charger so as to be repeatedly used. The battery pack 6 is versatile enough to be used as a power source for other power tools. An electric motor 31 of the lift mechanism 30, which is described below, is operated by the electric power of the battery pack 6 as a power source.

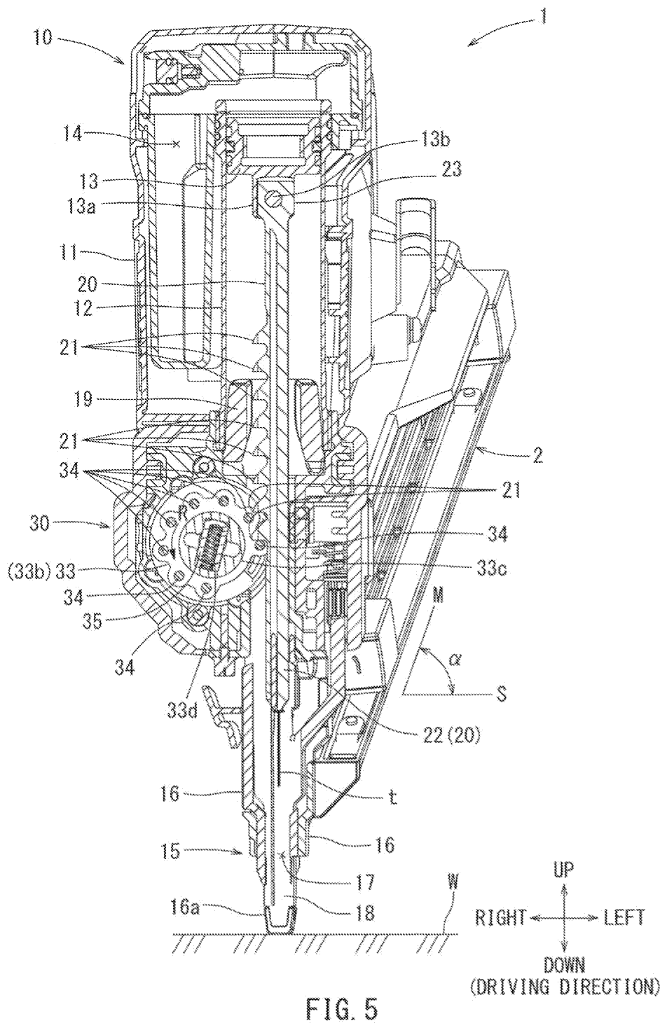

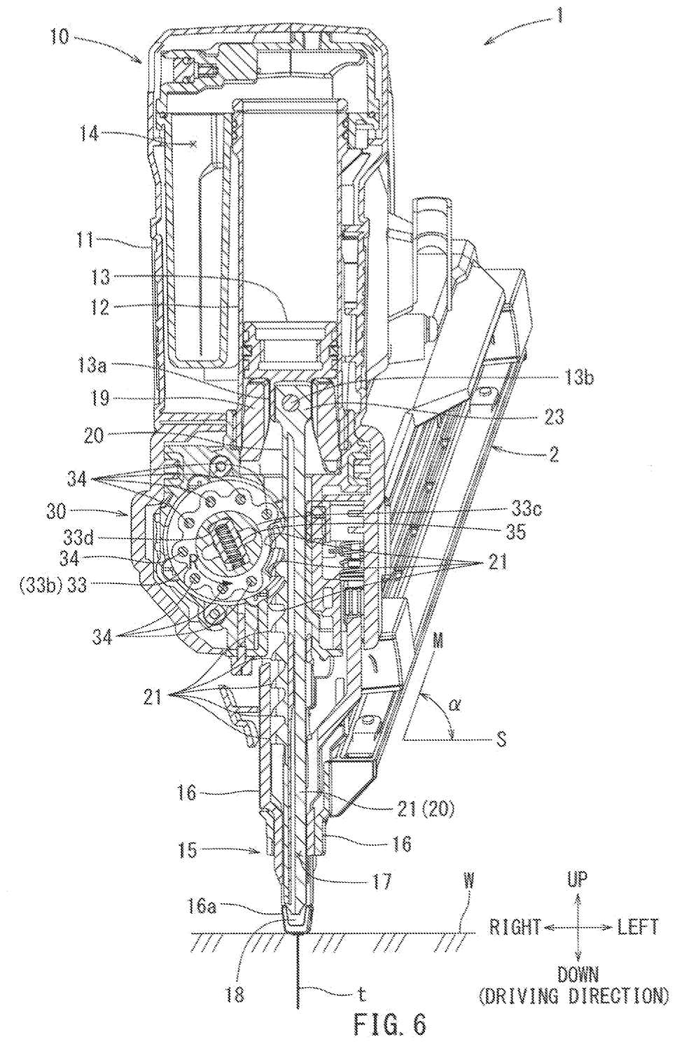

As shown in FIGS. 5 and 6, a downward motion end damper 19 is placed at a bottom of cylinder 12 to absorb shock at a downward motion end of piston 13. A driver 20 is coupled to a center of a lower side of the piston 13. The driver 20 extends long downward from the lower side of the piston 13. An end (lower side) of the driver 20 in the driving direction passes through an inner circumference of the downward motion end damper 19 and enters the driving channel 17. The driver 20 is movable downward in the driving channel 17 by the gas pressure of the pressure accumulation chamber 14 acting on the upper surface of the piston 13. The end of the driver 20 moving downward in the driving channel 17 strikes one driven member t fed in the driving channel 17. As shown in FIG. 6, when the piston 13 reaches the downward motion end, the struck driven member t is ejected from an ejection port 18. The ejected driven member t is then driven into the workpiece W.

As shown in FIGS. 1 to 4, a lift mechanism 30 is provided below the grip 3. The lift mechanism 30 is disposed over the rear side of the tool body 10 and the battery mounting portion 5. The lift mechanism 30 has an electric motor 31 as a drive source. One lifter 33 is supported in front of the electric motor 31 via a reduction gear train 32. As shown in FIG. 6, the driver 20 and piston 13, which have reached the downward motion end, are returned by the lift mechanism 30 to the upper initial position (the position shown in FIG. 5).

As shown in FIGS. 5 and 6, a number (e.g., eight) of engaging portions 21 are provided on a right side of the driver 20. Each engaging portion 21 has a corrugated rack-tooth shape projecting to the right. The plurality of engaging portions 21 may be arranged at constant intervals in the longitudinal direction (up-down direction) of the driver 20. The lifter 33 of the lift mechanism 30 is successively engaged with the plurality of engaging portions 21.

A lifter 33 is disposed on a right side of the driver 20. The lifter 33 has a number (e.g., eight) of engagement pins 34 that are successively engaged with the engaging portions 21 of the driver 20. A cylindrical shaft member is used for each engagement pin 34. The engagement pins 34 may be arranged at constant intervals along the outer circumferential edge of the lifter 33.

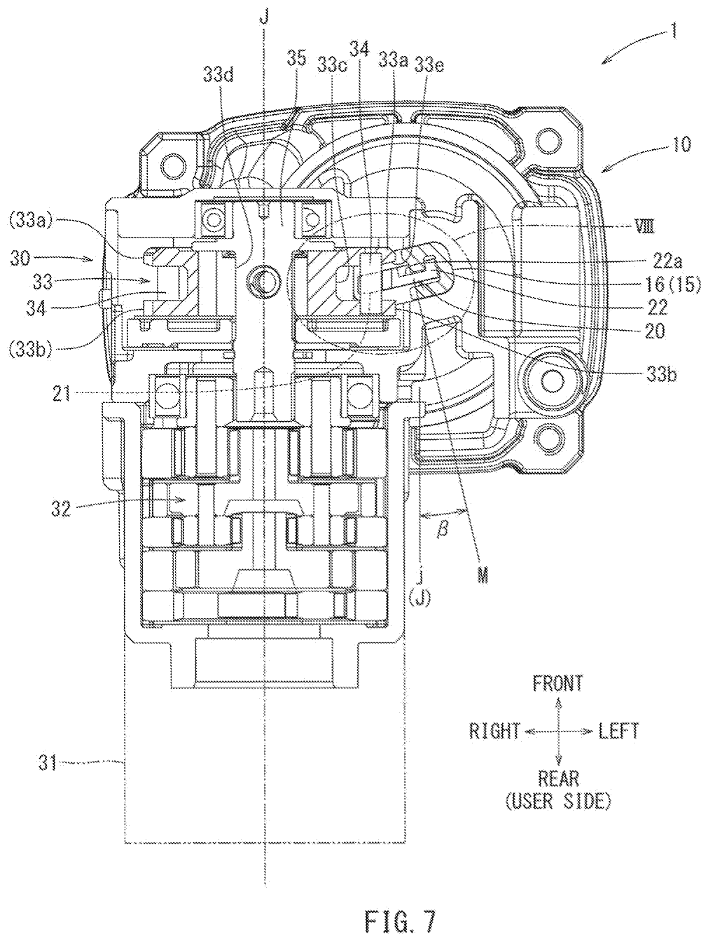

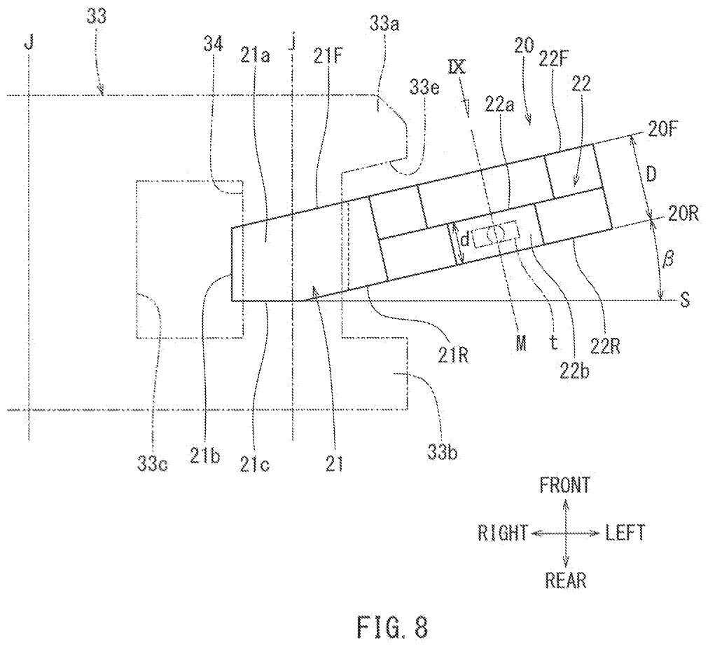

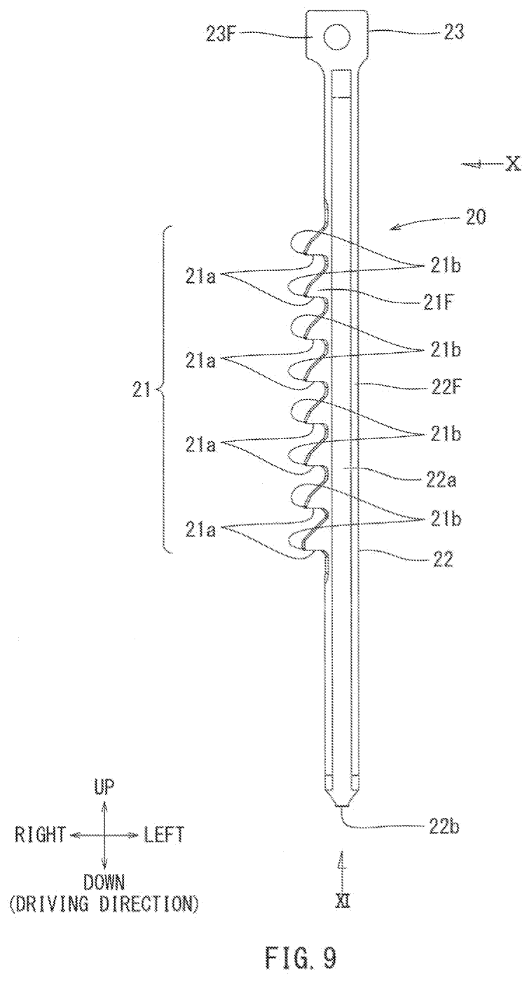

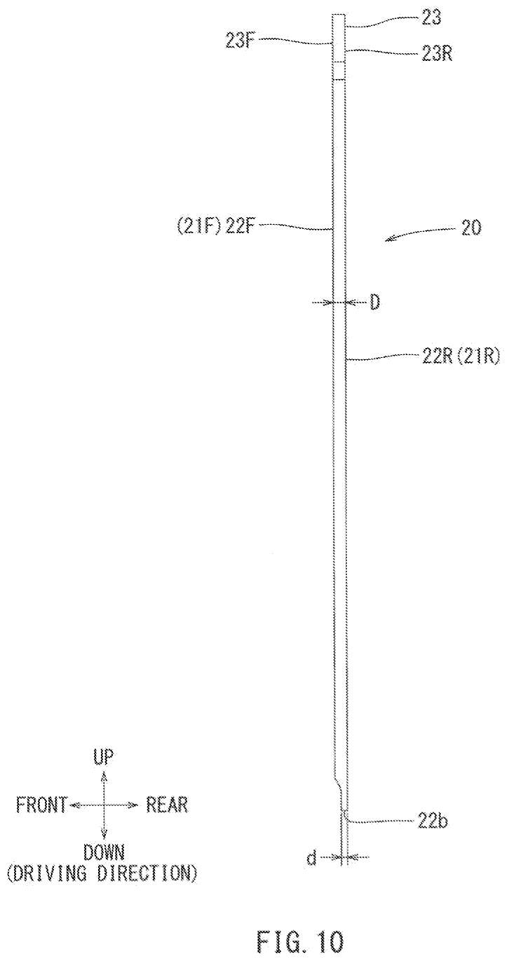

As shown in FIGS. 7 and 8, the lifter 33 integrally has front flange 33a on a front side, a rear flange 33b on a rear side, and a body 33c. The front flange 33a and rear flange 33b radially extend parallel to each other from an edge of the body 33c. An output shaft (rotary shaft) 35 of the reduction gear train 32 is inserted into an inner circumferential hole 33d of the body 33c. Through the inner circumferential hole 33d in the body 33c, the lifter 33 is integrally rotated with the output shaft 35. The engagement pins 34 are supported at both ends over the front flange 33a and the rear flange 33b.

A relief surface 33e is formed all around a rear side of the front flange 33a. The relief surface 33e is inclined at a certain angle (e.g., the feeding angle β of the magazine 2) with respect to the reference plane S orthogonal to the rotation axis J of the lifter 33. This allows the driver 20 to be positioned closer to the lifter 33 while avoiding interference of the front surface 21F of the engaging portion of the driver 20 with the front flange 33A of the lifter 33. This makes the lift mechanism 30 and the driving nose section 15 more compact.

A large interval in the rotational direction (an area where the engagement pins 34 do not exist) is provided between the first and last engagement pins 34 of the lifter 33 in the rotational direction. When this interval is directed toward the driver 20, the lifter 33 is disengaged from the engaging portion 21 of the driver 20. FIG. 5 shows a standby state just before a disengaged state. FIG. 6 shows a driving state in which the engaged state is released.

An activation of the electric motor 31 causes the lifter 33 to rotate in a direction of an arrow R (counterclockwise in FIGS. 5 and 6). After the driver 20 has reached the downward motion end as shown in FIG. 6, a rotation of the lifter 33 in the direction of arrow R causes the driver 20 to return upward as the engagement pins 34 are successively engaged with the engaging portions 21 of the driver 20 from below. As the piston 13 returns upward via the lift mechanism 30, the gas pressure in the pressure accumulation chamber 14 increases. When the driver 20 returns to the initial position as shown in FIG. 5, the electric motor 31 stops and the series of driving operations will end.

When the switch lever 4 is pulled again, the lift mechanism 30 is restarted. This causes the lifter 33 to rotate in the direction of arrow R, and the lifter 33 to disengages from the engaging portions 21 of the driver 20. The driver 20 then moves downward due to the gas pressure of the pressure accumulation chamber 14 that acts on the piston 13. As the driver 20 moves downward through the driving channel 17, the driven member t is struck and driven into the workpiece W.

A portion of the driver 20 excluding the engaging portions 21 serves as the striking portion 22. A number of engaging portions 21 are provided along a right side of the striking portion 22, and a coupling portion 23 is provided at a top of the striking portion 22. A bifurcated connecting portion 13a is provided in the center of the lower side of the piston 13. The driver 20 is coupled at the lower side of the piston 13 as a connecting pin 13b is inserted after the coupling portion 23 of the driver 20 is inserted into the connecting portion 13a. This connects the driver 20 along a central axis of the piston 13.

The striking portion 22 has a strip shape with thickness D. The striking portion 22 has a mutually parallel front surface (striking portion front surface 22F) and a rear surface (striking portion rear surface 22R). A distance between the striking portion front surface 22F and the striking portion rear surface 22R corresponds to the thickness D. The front surface of each engaging portion 21 (front surface of engaging portion 21F) is flush with the striking portion front surface 22F. A rear surface of each engaging portion 21 (engaging portion rear surface 21R) is flush with the striking portion rear surface 22R. A front surface of the coupling portion 23 (coupling portion front surface 23F) is flush with the striking portion front surface 22F. A rear surface of the coupling portion 23 (coupling portion rear surface 23R) is flush with the striking portion rear surface 22R. The engaging portion front surface 21F, the striking portion front surface 22F and the coupling portion front surface 23F, which are flush with each other are hereinafter also collectively referred to as a front surface 20F of the driver 20. The engaging portion rear surface 21R, the striking portion rear surface 22R and the coupling portion rear surface 23R, which are flush with each other, are also referred to as a rear surface 20R of the driver 20.

One guide groove 22a is provided on the striking portion front surface 22F of the striking portion 22. The guide groove 22a is formed over the entire area of the striking portion 22 from a top to a lower end. A lower end surface of the striking portion 22 serves as a striking surface 22b for striking the driven member t. A thickness d of the striking surface 22b in the front-rear direction is thinner than the thickness D of the striking portion 22.

As shown in FIG. 8, each engaging portion 21 of the driver 20 has an engagement surface 21a corresponding to a side surface. Each engagement surface 21a includes a tip ridge 21b. Each engaging portion 21 is engaged with each engagement pin 34 with the tip ridge 21b positioned parallel to an axis of the engagement pin 34. Each axis J of each engagement pin 34 is parallel to the rotation axis J of the lifter 33. As described above, the magazine 2 is disposed with the feeding axis M inclined to the left at the feeding angle β relative to the rotation axis J of the lifter 33. The tip ridge 21b of each engaging portion 21 is inclined in a direction that the tip ridge 21b is inclined with respect to the feeding axis M of the magazine 2 at the feeding angle β. Accordingly, the tip ridge 21b of each engaging portion 21 is parallel to the axis J of the engagement pin 34.

Each engagement surface 21a of each engaging portion 21 is orthogonal to the striking portion front surface 22F and striking portion rear surface 22R of the striking portion 22. This allows a striking surface 22b to strike a head of the driven member t in an appropriate orientation with respect to the head of the driven member t to be fed along the feeding axis M inclined at the feeding angle β (an orientation with the left-right direction of the striking surface 22b positioned parallel to the width direction of the driven member t). This allows an efficient striking operation.

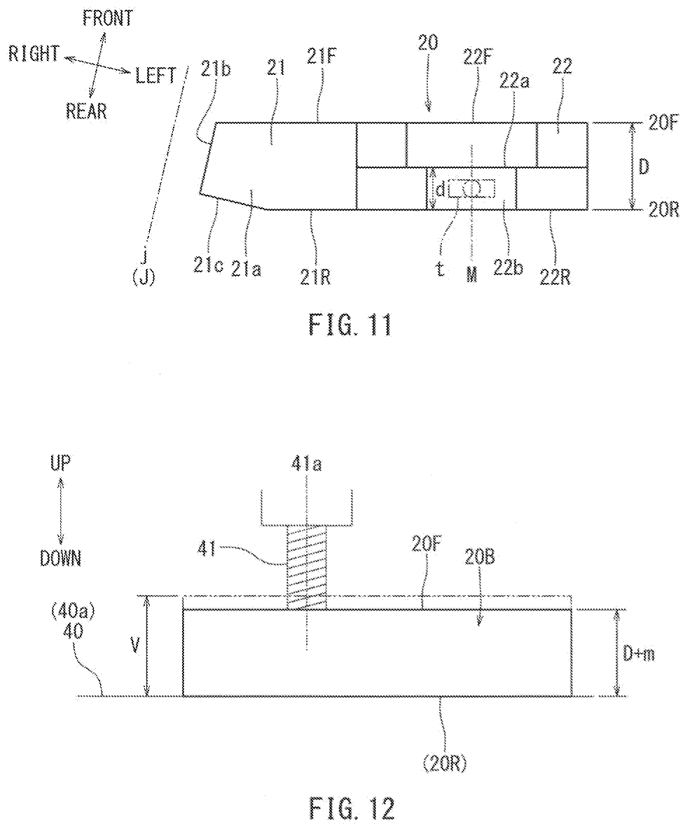

As shown in FIGS. 11 and 12, a material 20B with thickness D+machining allowance (cutting allowance) m is used to manufacture a driver 20 via a cutting work. In contrast, in the conventional driver, the engaging portion front surface is inclined with respect to the striking portion front surface, as indicated by the double-dotted line in FIG. 12. Therefore, the striking portion front surface and the engaging portion front surface are not coplanar. For this reason, it has been conventionally necessary to use a material with a larger thickness V (V>D+m) for the inclined engaging portion, and to perform the cutting work for a greater cutting allowance. Further, since the striking portion front surface and the engaging portion front surface were not coplanar, both surfaces could not be continuously cut at one time. In this embodiment, the striking portion front surface 22F, the engaging portion front surface 21F, and the coupling portion front surface 23F (front surface 20F of the driver 20) can be continuously cut at one time with less cutting allowance m for a material 20B of a smaller thickness (D+m) than that of the conventional one. This reduces the cost and simplifies the manufacturing process of the driver 20.

A method for manufacturing the driver 20 is disclose herein. Instead of an up-down direction of the driving tool 1, an up-down direction is used with reference to a setting surface 40A of a cutting machine 40 (above the setting surface and below the setting surface). As shown in FIG. 12, a flat material 20B with thickness D+cutting allowance m is set on the setting surface 40a of the cutting machine 40. In this process, the material 20B is set in a posture with the thickness D direction orthogonal to the setting surface 40a. First, a top surface of the material 20B (front surface 20F of the driver 20) is cut to a flat flush surface. In this process, cutting is performed at a right-angle machining position where a rotation axis 41a of a rotary cutting tool 41 is orthogonal to the setting surface 40a. This defines the front surface 20F (engaging portion front surface 21F, striking portion front surface 22F and coupling portion front surface 23F) of the driver 20. The cutting process is performed with less cutting allowance m compared to conventional materials of thickness V (>D).

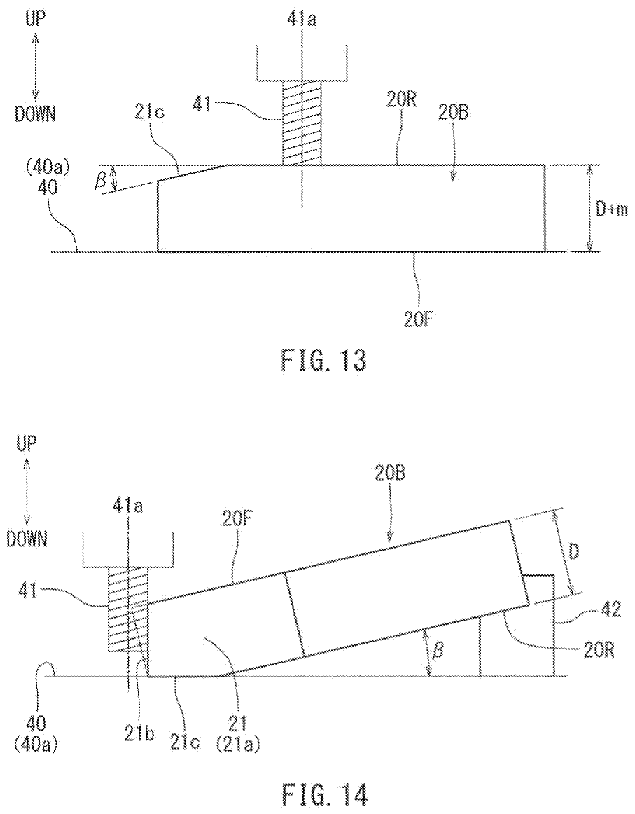

As shown in FIG. 13, after cutting the front surface 20F, the material 20B is set in an inverted posture, which is inverted in the thickness D direction. In this inverted posture, a bottom surface of material 20B faces upward as illustrated in FIG. 13. In this inverted position, the bottom surface of material 20B (shown as a top surface in FIG. 13) is cut for flushing. Also in this process, cutting work is performed at the right-angle machining position where the rotation axis 41a of the rotary cutting tool 41 is orthogonal to the set face 40a. This defines the rear surface 20R (engaging portion rear surface 21R, striking portion rear surface 22R and coupling portion rear surface 23R) of the driver 20. At this stage, the material 20B is cut with a thickness D.

Next, while still in the inverted position, a left rear surface corner of the material 20B is chamfered at a feeding angle β. This allows a relief surface 21c to be machined to avoid interference with the lifter 33. The relief surface 21c is cut, for example, by tilting the rotary cutting tool 41 at the feeding angle β.

Next, as shown in FIG. 14, the material 20B is reversed in the thickness D direction and set again. In this process, a top surface of the material 20B is oriented upward and set in an inclined position with the relief surface 21c that is parallel to the setting surface 40a, for example, using a machining jig 42. In this inclined posture, the top surface (front surface 20F of the driver 20) and the bottom surface (rear surface 20R of the driver 20) of the material 20B are inclined at a feeding angle β with respect to the setting surface 40a of the cutting machine 40.

Each of the engaging portions 21 is cut by the rotary cutting tool 41 while the material 20B cut to thickness D is set in an inclined posture at a feeding angle β. The rotary cutting tool 41 moves along a right edge of the material 20B to form the engaging portions 21. Also in this process, cutting is performed at a right-angle machining position where the rotation axis 41a of the rotary cutting tool 41 is orthogonal to the setting surface 40a. The engaging portions 21 are engaged with the engagement pins 34 of the lifter 33 when the driver 20 is assembled to the driving tool 1.

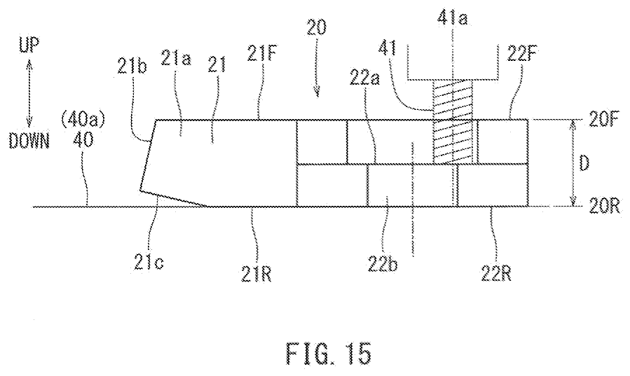

Next, as shown in FIG. 15, the material 20B is set in a horizontal posture with the top surface (front surface 20F of driver 20) oriented upward and the bottom surface (rear surface 20R of driver 20) that is being parallel to the setting surface 40A. In this horizontal posture, a guide groove 22a is cut on the top surface of the material 20B by the rotary cutting tool 41. As the rotary cutting tool 41 moves, the guide groove 22a is formed longitudinally along the longitudinal direction of the material 20B. In addition, a striking surface 22b is cut at an end of the material 20B by the rotary cutting tool 41. In this process, the cutting work is performed at the right-angle machining position where the rotation axis 41a of the rotary cutting tool 41 is orthogonal to the set face 40a. The driver 20 manufactured in the above process is assembled to the driving tool 1 with the engaging portion 21 oriented to the lifter 33 side.

According to the embodiment, the driving tool 1 has a magazine 2 in which the feeding direction of the driven member t is inclined at the feeding angle β to the left relative to the rotation axis J of the lifter 33. This reduces the cost and simplifies the method for manufacturing the driver 20.

The driver 20 has a flat plate shape with the thickness D direction oriented orthogonally to the feeding angle β, and includes a striking portion 22 that strikes the driven member t, and engaging portions 21 that project from the striking portion 22 toward the lifter 33 and engage with the lifter 33 successively. Each of the engaging portions 21 has a front surface 21F coplanar with the front surface 22F of the striking portion 22, and a rear surface 21R coplanar with the rear surface 22R of the striking portion 22. The engagement surface 21a of the engaging portions 21 is composed of a plane substantially parallel to the rotation axis J of the lifter 33.

Therefore, since the striking portion 22 and the engaging portions 21 have coplanar front and rear surfaces, the driver 20 can be manufactured with a minimum machining allowance m using a flat plate-shaped material 20B of sufficient thickness (D+m) to form the striking portion 22 and engaging portions 21 by cutting. This reduces the cost and simplifies the manufacturing process of the driver 20 in the driving tool 1 that has a magazine 2, in which the driven member t is fed in an inclined posture along the feeding axis M in a direction inclined to the left relative to the rotation axis J of the lifter 33.

According the embodiment, the front surface 20F and rear surface 20R of the driver 20 are formed by cutting the top and bottom surfaces, respectively, of a flat plate-shaped material 20B of thickness D with a minimum processing allowance m into one flat surface. A rotary cutting tool 41 is allowed to move along the edge of the material 20B to form a plurality of engaging portions 21 on the edge. In this case, the rotary cutting tool 41 cuts into the edge while being inclined at a feeding angle β with respect to the edge of the material 20B. Therefore, by cutting the material 20B of sufficient thickness required for the material with a minimum machining allowance m, a driver 20 for striking a driven member t with its feeding axis M inclined to the rotation axis J of the lifter 33 can be manufactured at a low cost.

According to the embodiment, the lifter 33 preferably has eight engagement pins 34 that successively engage with the engaging portions 21 of the driver 20. Accordingly, the driver 20 returns upward as these eight engagement pins 34 are successively engaged with the engaging portions 21.

According to the embodiment, the lifter 33 has a front flange 33a that supports front ends of the engagement pins 34, and a rear flange 33b that supports rear ends of the engagement pins 34. Accordingly, these eight engagement pins 34 are further supported at both ends by the front flange 33a and the rear flange 33b of the lifter 33, respectively.

According to the embodiment, the engaging portion rear surface 21R of the driver 20 is formed with a relief surface 21c that is inclined with respect to the engaging portion rear surface 21R to avoid interference with the rear flange 33b of the lifter 33. Accordingly, the driver 20 is positioned closer to the lifter 33, while avoiding interference of the engaging portion rear surface 21R with the rear flange 33b. This allows the lift mechanism 30 and the driving nose portion 15 to be made more compact.

According to the embodiment, the driver 20 has a plate-shaped coupling portion 23 that is coupled to the piston 13. The front surface 23F of the coupling portion 23 is flush with the front surface 22F of the striking portion 22, while the rear surface 23R of the coupling portion 23 is flush with the rear surface 22R of the striking portion 22. Thus, the driver 20 is coupled to the center of the lower side of the piston 13 via the coupling portion 23, which is flush with the striking portion 22.

According to the embodiment, the thickness d of the striking surface 22b of the striking portion 22 is thinner than the thickness D of the striking portion 22 (d<D), therefore, reduces the weight of the driver 20.

According to the embodiment, the front flange 33a of the lifter 33 has a relief surface 33e inclined to a plane orthogonal to the rotation axis J at the entire circumference to avoid interference with the engaging portion front surface 21F. Accordingly, the driver 20 may be positioned closer to the lifter 33 while avoiding interference of the engaging portion front surface 21F with the front flange 33a of the lifter 33.

According to the embodiment, the feeding angle β of the magazine 2 is set at 12.5° with respect to the direction parallel to the rotation axis J of the lifter 33. Therefore, the driven member t is fed into the driving channel 17 in an inclined posture at 12.5° with respect to the reference plane S orthogonal to the rotation axis J of the lifter 33.

According to the embodiment, in the manufacturing process of the driver 20, after the material 20B is set on the cutting machine 40 with its bottom surface (rear surface 20R of the driver 20) oriented upward, a relief surface 21c is cut on the top surface side of the engaging portion 21. The relief surface 21c may be formed, for example, at an inclination of a feeding angle β with respect to the reference plane S. Next, the material 20B is inverted upside down and set in an inclined posture where the relief surface 21c is parallel to the setting surface 40a of the cutting machine 40. Eight engaging portions 21 are cut in this inclined position.

Various modifications may be made to the embodiments described above. For example, one example was illustrated in which the feeding direction (feeding angle β) of the magazine 2 with respect to the rotation axis J of the lifter 33 is 12.5°, however, the feeding direction of the magazine may be varied within the range of 5° to 15°, for example. A driver corresponding to a magazine with a feeding angle β of 5° to 15° may be manufactured using the processing method exemplary described in the embodiment to reduce the cost of the driver and make the lift mechanism more compact.

Although a configuration in which the driver 20 has eight engaging portions 21 was exemplary described in the embodiments, the processing method exemplary described in the embodiments may be applied to a driver having, for example, six or ten engaging portions.

The relief surface 21c of driver 20 may be omitted. The relief surface 33e of the lifter 33 may be omitted.

A configuration in which the thickness d of the striking surface 22b is thinner than the thickness D of the striking portion 22 (d<D) was exemplary described in the embodiment, however, it may be modified to the same thickness.

1. A driving tool comprising:
a driver that is movable in an up-down direction for striking a driven member;
a lifter allocated on either left side or right side of the driver, wherein the lifter rotates around a rotation axis extending in a front-rear direction to return the driver to its initial position; and
a magazine allocated on a side of the driver opposite to the lifter, wherein the magazine feeds driven members from rear to front at a feeding angle, wherein the feeding angle is inclined in a left-right direction relatively to the rotation axis of the lifter,
wherein the driver is planar with its thickness direction oriented in a feeding direction of the driven members, wherein the driver has a striking portion configured to strike the driven member and a plurality of engaging portions projecting from the striking portion toward the lifter to engage successively with the lifter,
wherein each of the plurality of engaging portions has an engaging portion front surface coplanar with a front surface of the striking portion and an engaging portion rear surface coplanar with a rear surface of the striking portion, and
wherein engagement surfaces of the plurality of engaging portions are configured in a plane that is substantially parallel to the rotation axis.

2. The driving tool according to claim 1 further comprising a plurality of engagement pins that are arranged along an outer circumferential edge of the lifter and successively engages with the plurality of engaging portions of the driver.

3. The driving tool according to claim 2, wherein the lifter includes a front flange to support a front end of the plurality of engagement pins and a rear flange to support a rear end of the plurality of engagement pins.

4. The driving tool according to claim 1, wherein the engaging portion rear surface of the driver has a relief surface that is inclined with respect to the engaging portion rear surface to avoid interference with the lifter.

5. The driving tool according to claim 1, further comprising a piston that is movable by gas pressure, wherein: the driver has a plate-shaped coupling portion that is coupled to the piston,
a front surface of the coupling portion is flush with the front surface of the striking portion, and
a rear surface of the coupling portion is flush with the rear surface of the striking portion.

6. The driving tool according to claim 1, wherein an end of the striking portion is thinner than a body of the striking portion.

7. The driving tool according to claim 3, wherein the front flange of the lifter has a relief surface around an entire circumference that is inclined with respect to a plane orthogonal to the rotation axis for avoiding interference with the engaging portion front surface.

8. The driving tool according to claim 1, wherein the feeding angle of the magazine is about 5° to 15° with respect to a direction parallel to the rotation axis of the lifter.

9. A method for manufacturing a driver of a driving tool according to claim 1, the method comprising steps of:
forming a front surface of the driver by setting a flat plate-shaped material in a cutting machine with its thickness direction being up and down, wherein a top surface of the material is cut into a single flat surface;
forming a rear surface of the driver by setting the material upside down with respect to a bottom surface of the material facing upward, wherein the bottom surface of the material is cut into a single flat surface;
setting the material on the cutting machine using a machining jig, wherein the top surface of the material is set at the feeding angle with respect to a setting surface of the cutting machine, and wherein a rotary cutting tool moves along an edge of the material to form a plurality of engaging portions of the driver on the edge; and
setting the material on the cutting machine, wherein the top surface of the material is parallel to the setting surface of the cutting machine, and wherein the rotary cutting tool moves along the top surface of the material to form a guide groove extending in a longitudinal direction of the material.

10. The method according to claim 9, wherein the step of forming the front surface of the material and the step of forming the rear surface of the material are performed at a right-angle machining position so that an axis of the rotary cutting tool is orthogonal to the setting surface.

11. The method according to claim 9 further comprises a step of forming a relief surface subsequently to the step of forming the rear surface of the driver by cutting a rear side corner of the material in a direction inclined at the feeding angle.

12. A driving tool comprising:
a tool body having a body housing and a cylinder allocated within the body housing;
a piston being reciprocally movable in an up-down direction within the cylinder;
a driver coupled to the piston via a coupling portion, wherein the driver is movable in an up-down direction for striking a driven member;
a lifter allocated on either left side or right side of the driver, wherein the lifter rotates around a rotation axis extending in a front-rear direction to return the driver to its initial position; and
a magazine allocated on an opposite side of the lifter to the driver, wherein the magazine feeds driven members from rear to front at a feeding angle, wherein the feeding angle is inclined in a left-right direction relatively to the rotation axis of the lifter,
wherein the driver is planar with its thickness direction oriented in the feeding direction of the driven members,
wherein the driver has a striking portion configured to strike the driven member and a plurality of engaging portions projecting from the striking portion toward the lifter to engage successively with the lifter,
wherein each of the plurality of engaging portions has an engaging portion front surface coplanar with a front surface of the striking portion and an engaging portion rear surface coplanar with a rear surface of the striking portion, and
wherein engagement surfaces of the plurality of engaging portions are configured in a plane that is substantially parallel to the axis of rotation.

13. The driving tool according to claim 12, wherein the tool body comprises a driving nose portion, wherein the driving nose portion further comprises a driver guide and a contact arm.

14. The driving tool according to claim 12, wherein the magazine is coupled to the driving nose portion at a rear side.

15. The driving tool according to claim 12, wherein the cylinder comprises a downward motion end damper allocated at a bottom of the cylinder for shock absorption.

16. The driving tool according to claim 12 further comprises a lift mechanism configured for returning the driver and the piston to an upper initial position after the driver and the piston reaches downward motion end.

17. The driving tool according to claim 12, wherein the lifter further comprises a plurality of engagement pins, wherein each of the plurality of engagement pins is configured to engage with each of the plurality of engaging portions.

18. The driving tool according to claim 17, wherein the lifter further comprises a front flange for supporting a front end of each of the plurality of engagement pins.

19. The driving tool according to claim 17, wherein the lifter further comprises a rear flange for supporting a rear end of each of the plurality of engagement pins.

20. The driving tool according to claim 12, wherein the engaging portion rear surface is formed with a relief surface so that the relief surface is inclined with respect to the engaging portion rear surface.
